(19) United States
(12) Patent Application Publication
(10) Pub. No.: US 2025/0166388 A1
(43) Pub. Date: May 22, 2025

(54) IMAGE PROCESSING SYSTEM, IMAGE PROCESSING METHOD, AND NON-TRANSITORY STORAGE MEDIUM

(71) Applicant: NEC Corporation, Minato-ku, Tokyo (JP)

(72) Inventors: Yasuhiko OCHIAI, Tokyo (JP); Keisuke INOUE, Tokyo (JP); Motoharu OHTAKE, Tokyo (JP)

(73) Assignee: NEC Corporation, Minato-ku, Tokyo (JP)

(21) Appl. No.: 18/841,449

(22) PCT Filed: Mar. 3, 2022
(86) PCT No.: PCT/JP2022/009044

§ 371 Date: Aug. 26, 2024

(51) Int. Cl. G06V 20/54; G06V 40/10; G08G 1/01; G08G 1/04

(52) U.S. Cl. CPC G06V 20/54; G06V 40/10; G08G 1/0133; G08G 1/04

(57) ABSTRACT

The image processing system includes: a traffic volume calculation means for calculating at least one of a traffic volume of people and a traffic volume of vehicles by using a captured image of a road; a necessity degree estimation means for estimating a necessity degree that indicates a degree of necessity for executing animal detection processing of detecting an animal by using the captured image, based on the calculated traffic volume; an execution determination means for determining whether to execute the animal detection processing using the captured image, based on the estimated necessity degree; and an animal detection processing means for, when it is determined that the animal detection processing is to be executed, executing the animal detection processing using the captured image.

### TECHNICAL FIELD

The present disclosure relates to an image processing system, an image processing method, and an image processing program.

### BACKGROUND ART

In recent years, there has been an increasing number of cases where wild animals such as bears, deer, and wild boars are witnessed in villages. In this regard, various techniques have been proposed for detecting animals present on roads and in the vicinity thereof. As one example of such techniques, Patent Literature 1 discloses an image processing system that acquires an image of a road on which an own vehicle is traveling, being captured from a plurality of different directions, and detects a detection target such as a person or an animal from the image.

### CITATION LIST

### Patent Literature

Patent Literature 1: Japanese Unexamined Patent Application Publication No. 2017-055177

### SUMMARY OF INVENTION

### Technical Problem

However, when a system for detecting an animal at various locations is constructed by using the image processing system disclosed in Patent Literature 1, image analysis processing of detecting an animal is to be executed on a large number of captured images generated by a large number of image capturing apparatuses installed at various locations. Therefore, an amount of data to be processed in order to detect an animal becomes enormous, and there has been a problem that a processing load on the apparatus and usage of resources, such as memory, CPU, and network resources, increase.

In view of the above-described problem, an object of the present disclosure is to provide an image processing system, an image processing method, and an image processing program that are capable of reducing a processing load on an apparatus and usage of resources accompanying detection of an animal.

### Solution to Problem

An image processing system according to an example aspect includes:
a traffic volume calculation means for calculating at least one of a traffic volume of people and a traffic volume of vehicles by using a captured image of a road;
a necessity degree estimation means for estimating a necessity degree that indicates a degree of necessity for executing animal detection processing of detecting an animal by using the captured image, based on the calculated traffic volume;
an execution determination means for determining whether to execute the animal detection processing using the captured image, based on the estimated necessity degree; and
an animal detection processing means for, when it is determined that the animal detection processing is to be executed, executing the animal detection processing by using the captured image.

An image processing method according to an example aspect, being executed by an image processing apparatus configured to process an image, includes:
calculating at least one of a traffic volume of people and a traffic volume of vehicles by using a captured image of a road;
estimating a necessity degree that indicates a degree of necessity for executing animal detection processing of detecting an animal by using the captured image, based on the calculated traffic volume;
determining whether to execute the animal detection processing using the captured image, based on the estimated necessity degree; and,
when it is determined that the animal detection processing is to be executed, executing the animal detection processing by using the captured image.

An image processing program according to an example aspect causes a computer to execute:
a step of calculating at least one of a traffic volume of people and a traffic volume of vehicles by using a captured image of a road;
a step of estimating a necessity degree that indicates a degree of necessity for executing animal detection processing of detecting an animal by using the captured image, based on the calculated traffic volume;
a step of determining whether to execute the animal detection processing using the captured image, based on the estimated necessity degree; and
a step of, when it is determined that the animal detection process is to be executed, executing the animal detection processing by using the captured image.

An image processing system according to another example aspect includes:
a traffic volume calculation means for calculating at least one of a traffic volume of people and a traffic volume of vehicles by using a captured image of a road;
a necessity degree estimation means for estimating a necessity degree that indicates a degree of necessity for executing animal detection processing of detecting an animal by using the captured image, based on the calculated traffic volume; and
an execution determination means for determining whether to execute the animal detection processing using the captured image, based on the estimated necessity degree,
wherein, when it is determined that the animal detection processing is to be executed, the execution determination means causes an apparatus configured to execute the animal detection processing to execute the animal detection processing using the captured image.

An image processing method according to another example aspect, being executed by an image processing apparatus configured to processing an image, includes:
calculating at least one of a traffic volume of people and a traffic volume of vehicles by using a captured image of a road;
estimating a necessity degree that indicates a degree of necessity for executing animal detection processing of detecting an animal by using the captured image, based on the calculated traffic volume;
determining whether to execute the animal detection processing using the captured image, based on the estimated necessity degree; and,
when it is determined that the animal detection processing is to be executed, causing an apparatus configured to execute the animal detection processing to execute the animal detection processing using the captured image.

An image processing program according to another example aspect causes a computer to execute:
a step of calculating at least one of a traffic volume of people and a traffic volume of vehicles by using a captured image of a road;
a step of estimating a necessity degree that indicates a degree of necessity for executing animal detection processing of detecting an animal by using the captured image, based on the calculated traffic volume;

a step of determining whether to execute the animal detection processing using the captured image, based on the estimated necessity degree; and
a step of, when it is determined that the animal detection processing is to be executed, causing an apparatus configured to execute the animal detection processing to execute the animal detection processing using the captured image.

### Advantageous Effects of Invention

According to the present disclosure, it is possible to provide an image processing system, an image processing method, and an image processing program that are capable of reducing a processing load on an apparatus and usage of resources accompanying detection of an animal.

### BRIEF DESCRIPTION OF DRAWINGS

FIG. 1 is a diagram illustrating an image processing system according to an exemplary first example embodiment;

FIG. 2 is a diagram illustrating a configuration of an image processing apparatus according to the first example embodiment;

FIG. 3 is a diagram illustrating one example of a necessity degree estimation table for estimating a necessity degree by using a traffic volume of people and a traffic volume of vehicles;

FIG. 4 is a diagram illustrating one example of a necessity degree estimation table for estimating a necessity degree by using a traffic volume of people;

FIG. 5 is a diagram illustrating one example of a necessity degree estimation table for estimating a necessity degree by using a traffic volume of vehicles;

FIG. 6 is a diagram illustrating another example of the necessity degree estimation table for estimating the necessity degree by using the traffic volume of people and the traffic volume of vehicles;

FIG. 7 is a diagram illustrating another example of the necessity degree estimation table for estimating the necessity degree by using the traffic volume of people;

FIG. 8 is a diagram illustrating another example of the necessity degree estimation table for estimating the necessity degree by using the traffic volume of vehicles;

FIG. 9 is a diagram illustrating another example of the necessity degree estimation table for estimating the necessity degree by using the traffic volume of people and the traffic volume of vehicles;

FIG. 10 is a diagram illustrating another example of the necessity degree estimation table for estimating the necessity degree by using the traffic volume of people;

FIG. 11 is a diagram illustrating another example of the necessity degree estimation table for estimating the necessity degree by using the traffic volume of vehicles;

FIG. 12 is a flowchart illustrating one example of processing executed by the image processing apparatus according to the first example embodiment;

FIG. 13 is a flowchart illustrating one example of processing executed by the image processing apparatus according to the first example embodiment;

FIG. 14 is a block diagram illustrating the main components of the image processing system according to the first example embodiment;

FIG. 15 is a diagram illustrating a configuration of an image processing apparatus according to an exemplary third example embodiment; and

FIG. 16 is a block diagram illustrating the main components of an image processing system according to the third example embodiment.

### EXAMPLE EMBODIMENT

### First Example Embodiment

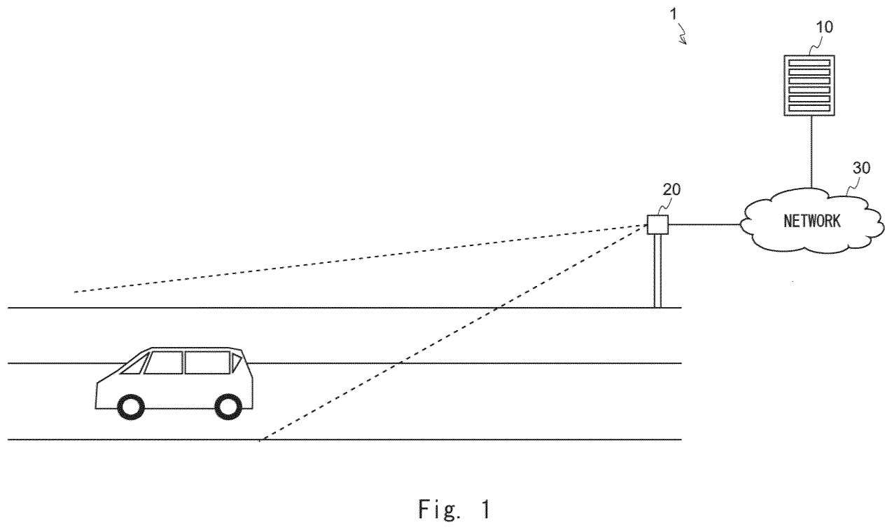

Hereinafter, example embodiments are described with reference to the drawings. FIG. 1 is a diagram illustrating an image processing system 1 according to an exemplary first example embodiment. The image processing system 1 includes an image processing apparatus 10 and one or more image capturing apparatuses 20.

The image capturing apparatus 20 is an apparatus configured to capture an image of a road. The image capturing apparatus 20 can be installed directly above the road or in the vicinity of the road. The image capturing apparatus 20 constantly captures an image of a road to be captured to generate a captured image, and provides the captured image to the image processing apparatus 10 via a network 30. The network 30 may be constructed in a wireless and/or wired manner. The network 30 may include various networks such as a local area network (LAN) and/or a wide area network (WAN).

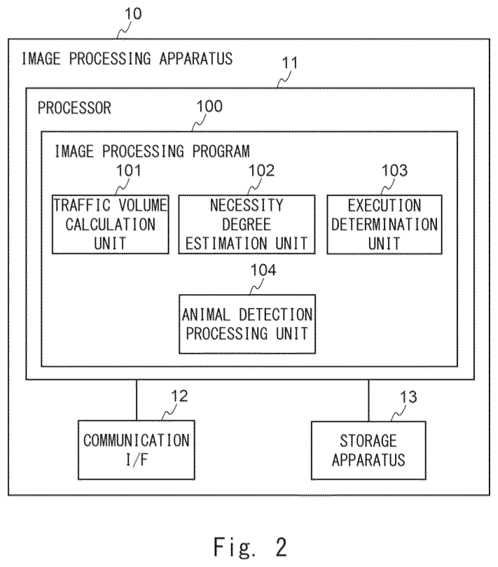

The image processing apparatus 10 is an apparatus configured to process a captured image generated by the image capturing apparatus 20. A specific example of the image processing apparatus 10 is a computer such as a server in a client-server system. FIG. 2 is a diagram illustrating a configuration of the image processing apparatus 10 according to the first example embodiment. The image processing apparatus 10 includes a processor 11 capable of executing various programs, a communication interface (I/F) 12, and a storage apparatus 13. Specific examples of the processor 11 include various processors such as a central processing unit (CPU) and a micro processing unit (MPU).

The image processing apparatus 10 receives a captured image transmitted from the image capturing apparatus 20 via the communication interface 12. Upon receiving the captured image, the image processing apparatus 10 stores the captured image in the storage apparatus 13. In addition to the captured image, the storage apparatus 13 stores various kinds of information processed by the processor 11, for example, an image processing program 100, a data table, and the like.

The processor 11 executes an image processing method according to the first example embodiment by reading and executing the image processing program 100 from the storage apparatus 13. The image processing program 100 includes a traffic volume calculation unit 101, a necessity degree estimation unit 102, an execution determination unit 103, and an animal detection processing unit 104. The functions of the image processing program 100 may be achieved by an integrated circuit such as a field-programmable gate array (FPGA) or an application specific integrated circuit (ASIC). The integrated circuit such as a processor, an FPGA, and an ASIC correspond to a computer.

The traffic volume calculation unit 101 is a program for calculating at least one of a traffic volume of people and a traffic volume of vehicles by using the captured image generated by the image capturing apparatus 20. For example, the traffic volume calculation unit 101 can calculate the traffic volume of people and/or the traffic volume of vehicles by detecting people and/or vehicles present in the captured image and counting the numbers thereof. Further, the traffic volume calculation unit 101 may calculate the traffic volume of vehicles, based on traffic information received from an external road traffic information system. Further, the traffic volume calculation unit 101 may calculate the traffic volume of people and/or the traffic volume of vehicles, based on information from sensors other than the camera installed on the road.

The necessity degree estimation unit 102 is a program for estimating a necessity degree for executing animal detection processing of detecting an animal by using a captured image, based on the traffic volume of people and/or vehicles calculated by the traffic volume calculation unit 101. The necessity degree is an index indicating a degree of necessity for executing the animal detection processing using the captured image. In the present example embodiment, three types of indices of “large”, “medium”, and “small” are adopted as the necessity degree. In other example embodiments, two types of necessity degrees or four or more types of necessity degrees may be adopted. Further, any numerical value may be adopted as the necessity degree.

Specifically, the necessity degree estimation unit 102 can specify the necessity degree associated to the traffic volume of people and the traffic volume of vehicles calculated by the traffic volume calculation unit 101, by using the traffic volume of people and the traffic volume of vehicles, and a necessity degree set based on the appearance possibility of an animal having an activity range that includes the image-capturing target area, and degrees of influence of the animal on a person and on a vehicle. The necessity degree can be registered in a necessity degree estimation table being a data table. The necessity degree estimation table can be prepared for each type of animal.

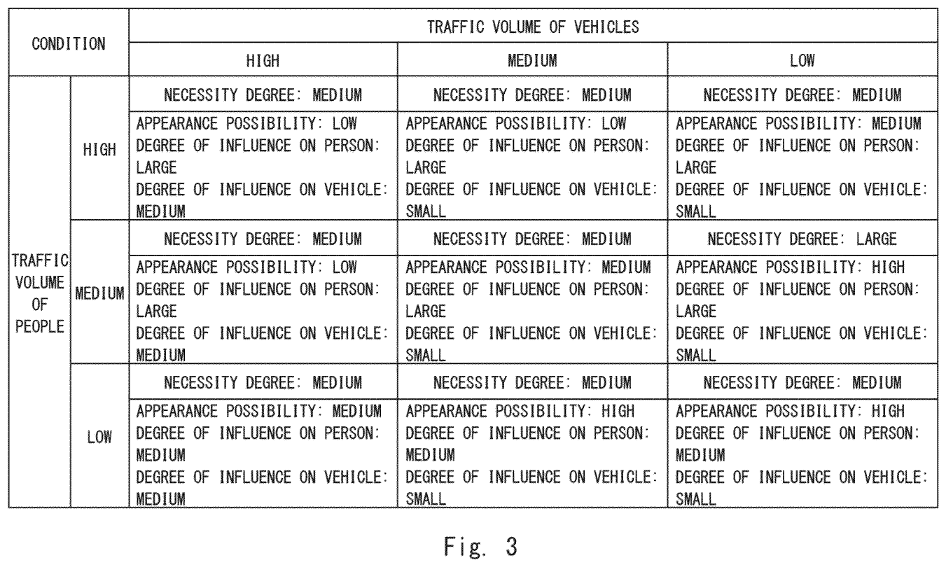

The necessity degree estimation tables illustrated in FIGS. 3 to 5 are examples of a necessity degree estimation table in which a necessity degree set on the assumption of a bear is registered. FIG. 3 illustrates one example of a necessity degree estimation table for estimating the necessity degree by using the traffic volume of people and the traffic volume of vehicles. In the necessity degree estimation table illustrated in FIG. 3, the traffic volume of people and the traffic volume of vehicles, and a necessity degree set based on an appearance possibility of the animal and the degrees of influence of the animal on a person and on a vehicle are registered.

As illustrated in the necessity degree estimation table of FIG. 3, since a bear is a beast, the degree of influence on a person may be set to “large” or “medium”. Meanwhile, a bear is unlikely to suddenly jump out to a road, but the damage caused when the bear collides with a vehicle is large, and therefore the degree of influence on a vehicle may be set to “medium” or “small”.

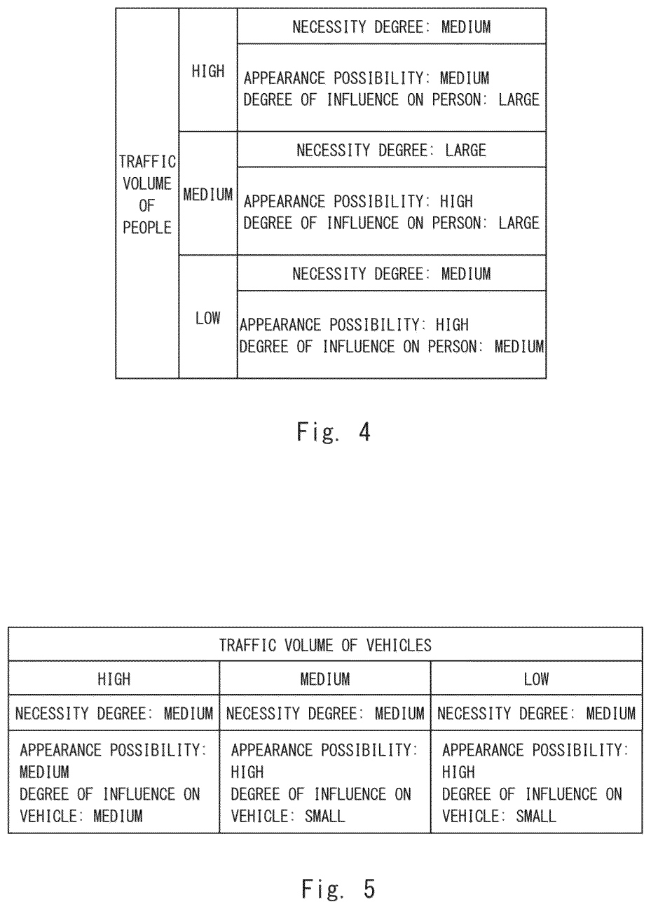

Further, the necessity degree estimation unit 102 can specify a necessity degree associated to the traffic volume of people calculated by the traffic volume calculation unit 101, by using the necessity degree set based on the traffic volume of people, the appearance possibility of the animal, and the degree of influence of the animal on a person. FIG. 4 illustrates one example of a necessity degree estimation table for estimating a necessity degree by using a traffic volume of people. In the necessity degree estimation table illustrated in FIG. 4, the traffic volume of people and a necessity degree set based on the appearance possibility of the animal and the degree of influence of the animal on a person is registered.

Further, the necessity degree estimation unit 102 can specify a necessity degree associated to the traffic volume of vehicles calculated by the traffic volume calculation unit 101, by using the necessity degree set based on the traffic volume of vehicles, the appearance possibility of the animal, and the degree of influence of the animal on a vehicle. FIG. 5 illustrates one example of a necessity degree estimation table for estimating a necessity degree by using a traffic volume of vehicles. In the necessity degree estimation table illustrated in FIG. 5, the traffic volume of vehicles, and a necessity degree set based on the appearance possibility of the animal and the degree of influence of the animal on a vehicle is registered.

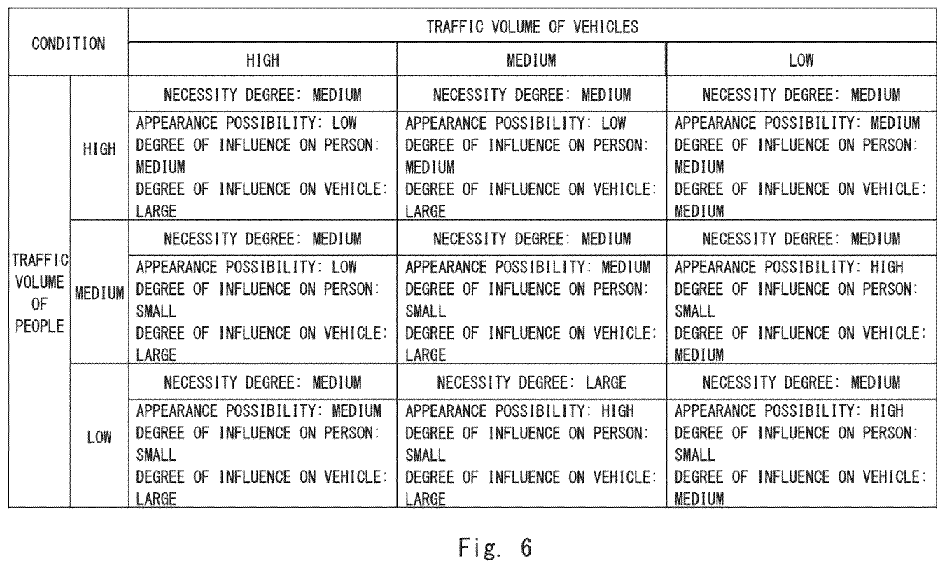

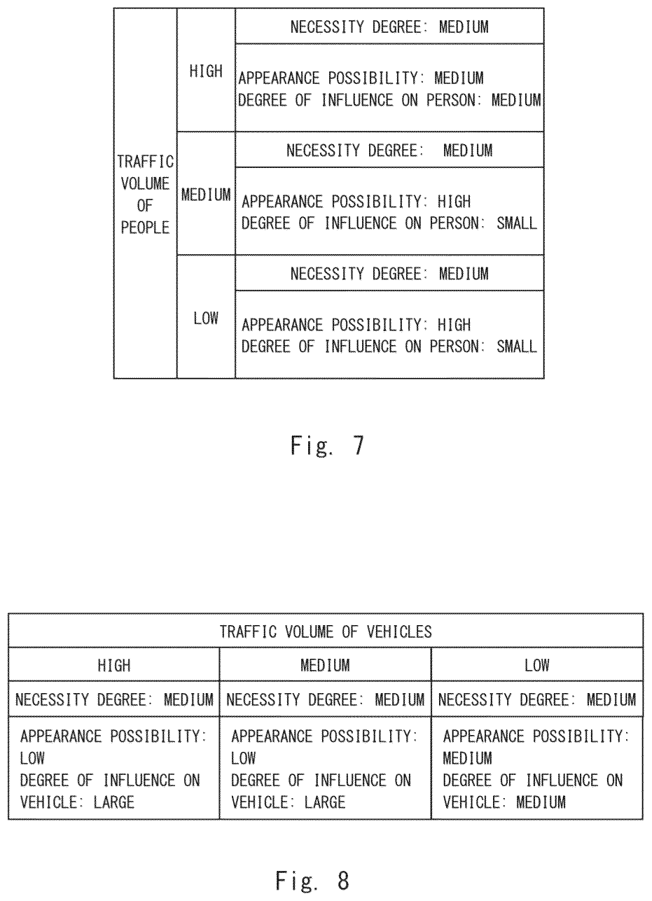

The necessity degree estimation tables illustrated in FIGS. 6 to 8 are examples of a necessity degree estimation table in which the necessity degree set on the assumption of deer is registered. FIG. 6 is one example of a necessity degree estimation table for estimating a necessity degree by using the traffic volume of people and the traffic volume of vehicles. FIG. 7 is one example of a necessity degree estimation table for estimating a necessity degree by using the traffic volume of people. FIG. 8 is one example of a necessity degree estimation table for estimating a necessity degree by using the traffic volume of vehicles.

As illustrated in the necessity degree estimation table of FIG. 6, in the case of a deer, there is a slight possibility that damage occurs due to colliding with a person, and therefore, the degree of influence on a person may be set to “medium” or “small”. Meanwhile, a deer may suddenly jump out to the road, and damage caused when colliding with a vehicle is large, and therefore the degree of influence on a vehicle may be set to “large” or “medium”.

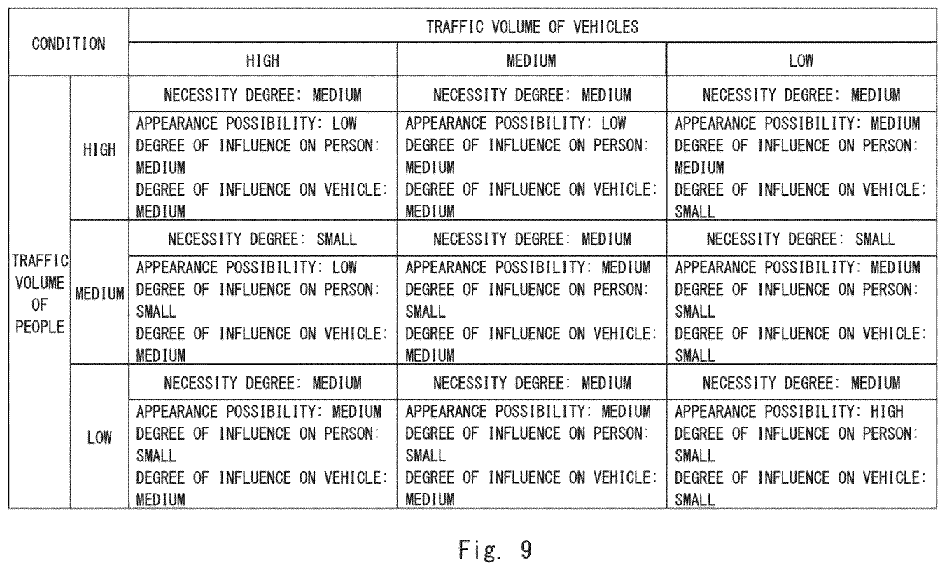

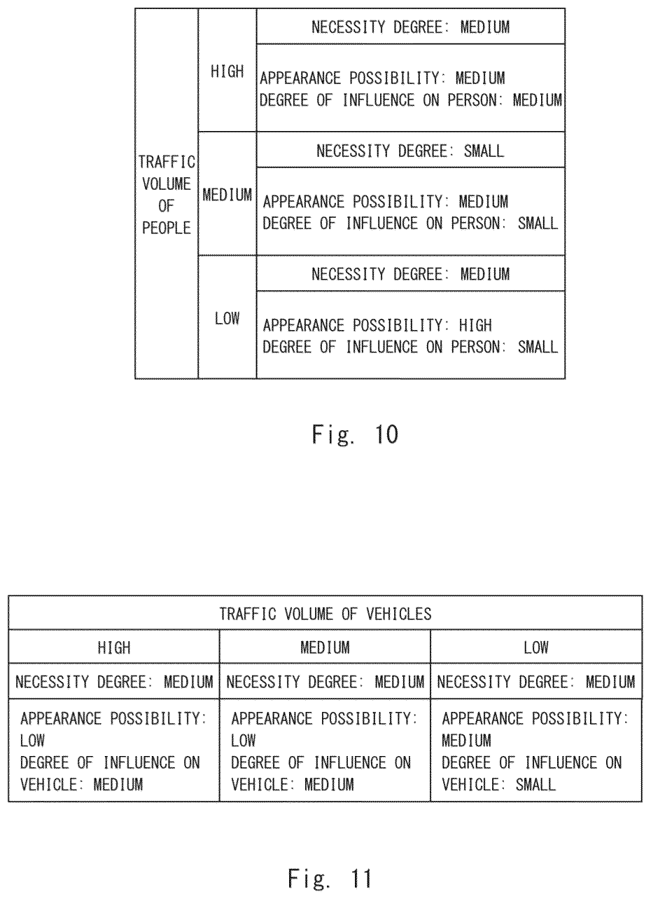

The necessity degree estimation tables illustrated in FIGS. 9 to 11 are examples of a necessity degree estimation table in which a necessity degree set on the assumption of a wild boar is registered. FIG. 9 is one example of a necessity degree estimation table for estimating a necessity degree by using the traffic volume of people and the traffic volume of vehicles. FIG. 10 is one example of a necessity degree estimation table for estimating a necessity degree by using the traffic volume of people. FIG. 11 is one example of a necessity degree estimation table for estimating a necessity degree by using the traffic volume of vehicles.

As illustrated in the necessity degree estimation table of FIG. 9, in the case of a wild boar, there is a slight possibility that damage occurs due to a collision with a person, and therefore, the degree of influence on a person may be set to “medium” or “small”. Meanwhile, a deer may suddenly jump out to the road, but damage caused when colliding with a vehicle is small, and therefore the degree of influence on a vehicle may be “medium” or “small”.

The necessity degree estimation unit 102 can use a necessity degree estimation table associated to an animal that is likely to appear in an area where the image capturing apparatus 20 is installed. For example, in a case where a captured image of the image capturing apparatus 20 installed in an area where a bear is likely to appear is being processed, the necessity degree estimation unit 102 can estimate a necessity degree by using the necessity degree estimation table (FIGS. 3 to 5) associated to a bear.

In addition, when there are a plurality of moving objects in the captured image other than the person and the vehicle, the necessity degree estimation unit 102 can estimate a necessity degree for each moving object. The moving objects are usually more likely to be animals. Therefore, the necessity degree estimation unit 102 can estimate the necessity degree for each of a plurality of animals present in the captured image.

In the present example embodiment, the necessity degree estimation unit 102 estimates the necessity degree by using the necessity degree registered in advance in the necessity degree estimation table, but in other example embodiments, the necessity degree estimation unit 102 may calculate the necessity degree by using the appearance possibility of the animal, the degree of influence of the animal on a person, and/or the degree of influence of the animal on a vehicle, without registering the necessity degree in advance in the data table.

For example, the necessity degree may be an average of the appearance possibility of the animal, the degree of influence of the animal on a person, and the degree of influence of the animal on a vehicle. In addition, the maximum value of the appearance possibility of the animal, the degree of influence of the animal on a person, and the degree of influence of the animal on a vehicle may be used as the necessity degree. In such a case, for example, when there is even one degree of influence “large”, the necessity degree is “large”. In addition, a value acquired by adding a predetermined weight to the appearance possibility of the animal, the degree of influence of the animal on a person, and the degree of influence of the animal on a vehicle may be used as the necessity degree.

The execution determination unit 103 is a program that determines whether to execute animal detection processing using the captured image, based on the necessity degree estimated by the necessity degree estimation unit 102. The execution determination unit 103 can determine that the animal detection processing is to be executed when the necessity degree estimated by the necessity degree estimation unit 102 is a specific necessity degree. For example, the execution determination unit 103 can determine that the animal detection processing is to be executed when the necessity degree estimated by the necessity degree estimation unit 102 is “large”. In the example embodiments in which the necessity degree is defined by a numerical value, the execution determination unit 103 can determine that the animal detection processing is to be executed when the necessity degree estimated by the necessity degree estimation unit 102 is equal to or greater than a predetermined threshold value.

The animal detection processing unit 104 is a program that executes animal detection processing using a captured image. The animal detection processing unit 104 executes the animal detection processing only when the execution determination unit 103 determines that the animal detection processing is to be executed. The animal detection processing unit 104 can analyze a captured image by using various image analysis algorithms capable of detecting an animal, and output an analysis result thereof. The animal detection processing unit 104 can use an image analysis algorithm for each type of animal that may appear in the image-capturing target area.

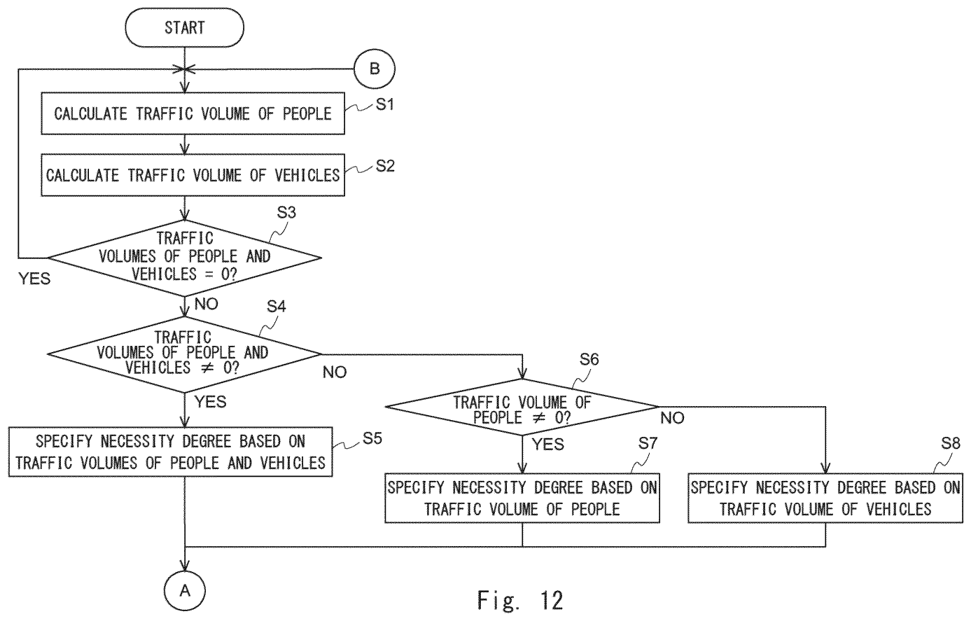

FIGS. 12 and 13 are flowcharts each illustrating an example of processing executed by the image processing apparatus 10. In step S1, the traffic volume calculation unit 101 selects at least one of the captured images received by the image processing apparatus 10, and calculates the traffic volume of people by using the selected captured image. In step S2, the traffic volume calculation unit 101 calculates the traffic volume of vehicles by using the selected captured image.

In step S3, the necessity degree estimation unit 102 determines whether both the traffic volume of people and the traffic volume of vehicles calculated by the traffic volume calculation unit 101 are zero. When both the traffic volume of people and the traffic volume of vehicles are zero (YES), the process returns to step S1. Thereafter, the processing illustrated in FIGS. 12 and 13 is executed for another captured image.

Meanwhile, when the traffic volume of people and the traffic volume of vehicles are not zero (NO), the process branches to step S4. In step S4, the necessity degree estimation unit 102 determines whether both the traffic volume of people and the traffic volume of vehicles calculated by the traffic volume calculation unit 101 are not zero. When both of the traffic volume of people and the traffic volume of vehicles are not zero (YES), in step S5, the necessity degree estimation unit 102 refers to the necessity degree estimation table for estimating the necessity degree by using the traffic volume of people and the traffic volume of vehicles, and specifies a necessity degree associated to the traffic volume of people and the traffic volume of vehicles calculated by the traffic volume calculation unit 101.

Meanwhile, when it is determined in step S4 that either the traffic volume of people or the traffic volume of vehicles is zero (NO), the process branches to step S6. In step S6, the necessity degree estimation unit 102 determines whether the traffic volume of people calculated by the traffic volume calculation unit 101 is not zero. When the traffic volume of people is not zero (YES), in step S7, the necessity degree estimation unit 102 refers to the necessity degree estimation table for estimating the necessity degree by using the traffic volume of people, and specifies a necessity degree associated to the traffic volume of people calculated by the traffic volume calculation unit 101.

Meanwhile, when it is determined in step S6 that the traffic volume of people is zero (NO), that is, when the traffic volume of vehicles is not zero, in step S8, the necessity degree estimation unit 102 refers to the necessity degree estimation table for estimating the necessity degree by using the traffic volume of vehicles, and specifies a necessity degree associated to the traffic volume of vehicles calculated by the traffic volume calculation unit 101.

In step S9, the execution determination unit 103 determines whether to execute the animal detection processing using the captured image selected in step S1, based on the necessity degree specified by the necessity degree estimation unit 102. When it is determined that the animal detection processing is not to be executed (NO), the process returns to step S1. Thereafter, the processing illustrated in FIGS. 12 and 13 is executed for another captured image.

Meanwhile, when it is determined that the animal detection processing is to be executed (YES), the process branches to step S10. In step S10, the animal detection processing unit 104 executes the animal detection processing using the captured image selected in step S1, and the process returns to step S1.

Thereafter, the processing illustrated in FIGS. 12 and 13 is executed for another captured image.

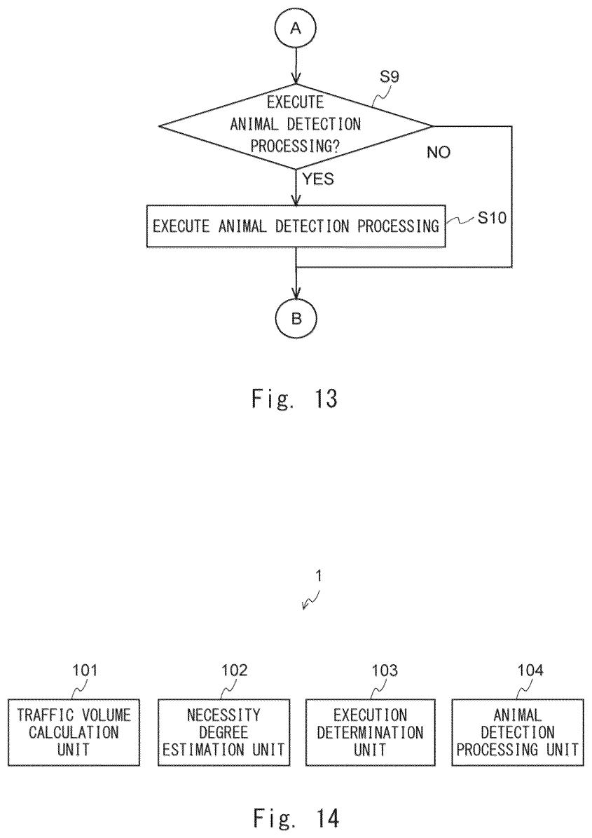

FIG. 14 is a block diagram illustrating the main components of the image processing system I according to the first example embodiment. The image processing system 1 includes the traffic volume calculation unit 101, the necessity degree estimation unit 102, the execution determination unit 103, and the animal detection processing unit 104. The traffic volume calculation unit 101, the necessity degree estimation unit 102, the execution determination unit 103, and the animal detection processing unit 104 may be implemented in a single image processing apparatus that functions as a server in a client-server system. Alternatively, the traffic volume calculation unit 101, the necessity degree estimation unit 102, the execution determination unit 103, and the animal detection processing unit 104 may be implemented in individual image processing apparatuses each functioning as a server. These image processing apparatuses correspond to the image processing system 1.

The traffic volume calculation unit 101 calculates at least one of the traffic volume of people and the traffic volume of vehicles by using the captured image. The necessity degree estimation unit 102 estimates a necessity degree, which indicates a degree of necessity for executing animal detection processing of detecting an animal by using a captured image, based on the calculated traffic volume. The execution determination unit 103 determines whether to execute the animal detection processing using the captured image, based on the estimated necessity degree. When it is determined that the animal detection processing is to be executed, the animal detection processing unit 104 executes the animal detection processing using the captured image.

Accordingly, since the animal detection processing using the captured image is executed only when it is determined that the animal detection processing is to be executed, the amount of data accompanying the animal detection processing can be reduced. As a result, the processing load on the image processing apparatus 10 that executes the animal detection processing can be reduced, and the usage of resources such as a memory, a CPU, and a data bus of the image processing apparatus 10 accompanying the execution of the animal detection processing can be reduced.

Further, the necessity degree estimation unit 102 specifies a necessity degree associated to the calculated traffic volume of people, based on the appearance possibility of the animal and the degree of influence of the animal on a person which are predetermined in association with the traffic volume of people. Accordingly, it is possible to estimate a necessity degree in which the traffic volume of people, the appearance possibility of the animal, and the degree of influence of the animal on a person are taken into consideration.

Further, the necessity degree estimation unit 102 specifies the necessity degree associated to the calculated traffic volume of vehicles, based on the appearance possibility of the animal and the degree of influence of the animal on a vehicle which are predetermined in association with the traffic volume of vehicles. Accordingly, it is possible to estimate a necessity degree in which the traffic volume of vehicles, the appearance possibility of the animal, and the degree of influence of the animal on a vehicle are taken into consideration.

Further, the necessity degree estimation unit 102 specifies the necessity degree associated to the calculated traffic volume of people and traffic volume of vehicles, based on the appearance possibility of the animal and the degree of influence of the animal on a person and the degree of influence of the animal on a vehicle, which are predetermined in association with the traffic volume of people and the traffic volume of vehicles. Accordingly, it is possible to estimate a necessity degree in which the traffic volume of people, the traffic volume of vehicles, the appearance possibility of the animal, and the degree of influence of the animal on a person and on a vehicle are taken into consideration.

In addition, the set necessity degree can serve as a necessity degree that is set according to the type of an animal, the activity range of which includes the location where the image capturing apparatus that generated the captured image is installed. Accordingly, the necessity degree can be estimated according to the type of the animal.

### Second Example Embodiment

In the exemplary second example embodiment, a necessity degree estimation unit 102 is able to determine a necessity degree, based on a traffic volume of people or a traffic volume of vehicles and characteristic of an animal having an activity range including the image-capturing target area. As the characteristics of the animal, for example, the nature of the animal can be adopted.

For example, in a case of an animal having a timid nature, when the traffic volume of people is equal to or larger than a predetermined traffic volume, the necessity degree estimation unit 102 can determine that the necessity degree is “none”. The predetermined traffic volume may be the smallest traffic volume of people in which the animal is unlikely to appear in the image-capturing target area. Meanwhile, when the traffic volume of people is less than the predetermined traffic volume, the necessity degree estimation unit 102 can determine that the necessity degree “exists”. Accordingly, the necessity degree can be determined based on the traffic volume of people and the characteristics of the animal.

Similarly, in the case of an animal having a timid character, when the traffic volume of vehicles is equal to or greater than a predetermined traffic volume, the necessity degree estimation unit 102 can determine that the necessity degree is “none”. The predetermined traffic volume may be the smallest traffic volume of vehicles in which the animal is unlikely to appear in the image-capturing target area. Meanwhile, when the traffic volume of vehicles is less than the predetermined traffic volume, the necessity degree estimation unit 102 can determine that the necessity degree “exists”. Accordingly, the necessity degree can be determined based on the traffic volume of vehicles and the characteristics of the animal.

In a case of an animal having a ferocious nature, the necessity degree estimation unit 102 can determine that the necessity degree “exists” only when there is traffic of people. Other than that, the necessity degree estimation unit 102 can determine that the necessity is “none”. Accordingly, the necessity degree can be determined based on the traffic volume of people and the characteristics of the animal.

When the necessity degree is determined to be “none”, the execution determination unit 103 determines not to execute the animal detection processing. On the other hand, when the necessity degree is determined to “exist”, the execution determination unit 103 determines to execute the animal detection processing.

### Third Example Embodiment

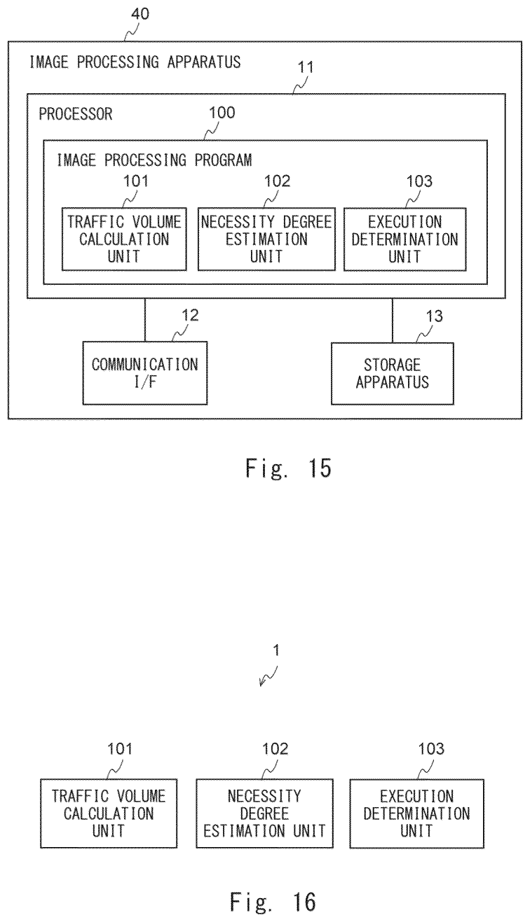

FIG. 15 is a diagram illustrating a configuration of an image processing apparatus 10 according to an exemplary third example embodiment. In the third example embodiment, an image processing apparatus 40 may be implemented as an edge server in edge computing. Hereinafter, differences from the first example embodiment and the second example embodiment are described.

An image processing program 100 includes a traffic volume calculation unit 101, a necessity degree estimation unit 102, and an execution determination unit 103. When the necessity degree estimation unit 102 determines to execute animal detection processing, the execution determination unit 103 causes an apparatus configured to execute the animal detection processing to execute the animal detection processing using a captured image. In the third example embodiment, an image processing apparatus separate from the image processing apparatus 40 executes the animal detection processing using the captured image. As the separate image processing apparatus, for example, a computer such as a server in a client-server system can be employed. Hereinafter, the image processing apparatus 40 is referred to as a first image processing apparatus, and the separate image processing apparatus is referred to as a second image processing apparatus.

The first image processing apparatus transmits, to the second image processing apparatus via a network, the captured image to be used in the animal detection processing together with an animal detection processing execution command. In the second image processing apparatus, upon reception of the animal detection processing execution command and the captured image from the first image processing apparatus, an animal detection processing unit 104 of the second image processing apparatus executes the animal detection processing using the captured image.

Accordingly, since the second image processing apparatus executes the animal detection processing using the captured image only when it is determined that the animal detection processing is to be executed, the amount of data accompanying the animal detection processing can be reduced. As a result, the processing load on the second image processing apparatus can be reduced, and the usage of resources such as a memory, a CPU, and a data bus of the second image processing apparatus can be reduced.

The first image processing apparatus transmits, to the second image processing apparatus via the network, the animal detection processing execution instruction and the captured image to be used in the animal detection processing only when it is determined that the animal detection processing is to be executed. Therefore, it is possible to reduce the usage of network resources such as a network apparatus (a hub, a router, or the like) and a communication path (a radio wave, a network cable, or the like).

FIG. 16 is a block diagram illustrating the main components of the image processing system 1 according to the third example embodiment. The image processing system 1 includes the traffic volume calculation unit 101, the necessity degree estimation unit 102, and the execution determination unit 103. The traffic volume calculation unit 101, the necessity degree estimation unit 102, and the execution determination unit 103 can be implemented in a single image processing apparatus that functions as an edge server. Alternatively, the traffic volume calculation unit 101, the necessity degree estimation unit 102, and the execution determination unit 103 may be implemented in individual image processing apparatuses that function as edge servers. These image processing apparatuses correspond to the image processing system 1.

In the examples described above, the image processing program 100 includes instructions (or software codes) that, when loaded onto a computer, cause the computer to execute one or more of the functions described in the example embodiments. The image processing program 100 may be stored in a non-transitory computer-readable medium or in a tangible storage medium. By way of example, and not limitation, computer-readable media or tangible storage media include a random-access memory (RAM), a read-only memory (ROM), a flash memory, a solid-state drive (SSD), or other memory technologies, a CD-ROM, a digital versatile disk (DVD), a Blu-ray (registered trademark) disk, or other optical disk storages, a magnetic cassette, a magnetic tape, a magnetic disk storage or other magnetic storage devices. The programs may be transmitted via a transitory computer readable medium or via a communication medium. By way of example, and not limitation, the transitory computer-readable media or communication media include an electrical, optical, acoustic, or other forms of propagated signals.

The present disclosure is not limited to the above-described example embodiments, and can be appropriately modified without departing from the spirit and scope of the present disclosure.

Some or all of the above-described example embodiments may be described as the following supplementary notes, but are not limited thereto.

### Supplementary Note 1

An image processing system including:
a traffic volume calculation means for calculating at least one of a traffic volume of people and a traffic volume of vehicles by using a captured image of a road;
a necessity degree estimation means for estimating a necessity degree that indicates a degree of necessity for executing animal detection processing of detecting an animal by using the captured image, based on the calculated traffic volume;
an execution determination means for determining whether to execute the animal detection processing using the captured image, based on the estimated necessity degree; and an animal detection processing means for, when it is determined that the animal detection processing is to be executed, executing the animal detection processing by using the captured image.

### Supplementary Note 2

The image processing system according to supplementary note 1, wherein the necessity degree estimation means specifies a necessity degree associated to the calculated traffic volume of people, based on an appearance possibility of the animal and a degree of influence of the animal on a person that are predetermined in association with the traffic volume of people.

### Supplementary Note 3

The image processing system according to supplementary notes 1 or 2, wherein the necessity degree estimation means specifies a necessity degree associated to the calculated traffic volume of vehicles, based on an appearance possibility of the animal and a degree of influence of the animal on a vehicle that are predetermined in association with the traffic volume of vehicles.

### Supplementary Note 4

The image processing system according to any one of supplementary notes 1 to 3, wherein the necessity degree estimation means specifies a necessity degree associated to the calculated traffic volume of people and traffic volume of vehicles, based on an appearance possibility of the animal, a degree of influence of the animal on a person, and a degree of influence of the animal on a vehicle that are predetermined in association with the traffic volume of people and the traffic volume of vehicles.

### Supplementary Note 5

The image processing system according to any one of supplementary notes 2 to 4, wherein the predetermined necessity degree is a necessity degree set according to a type of an animal, an activity range of which includes a location where the image capturing apparatus that generates the captured image is installed.

### Supplementary Note 6

The image processing system according to supplementary note 1, wherein the necessity degree estimation means determines the necessity degree, based on the traffic volume of people or the traffic volume of vehicles and a characteristic of the animal.

### Supplementary Note 7

An image processing method being executed by an image processing apparatus configured to process an image, the method including:
calculating at least one of a traffic volume of people and a traffic volume of vehicles by using a captured image of a road;
estimating a necessity degree that indicates a degree of necessity for executing animal detection processing of detecting an animal by using the captured image, based on the calculated traffic volume;
determining whether to execute the animal detection processing using the captured image, based on the estimated necessity degree; and, when it is determined that the animal detection processing is to be executed, executing the animal detection processing by using the captured image.

### Supplementary Note 8

A non-transitory storage medium storing an image processing program that causes a computer to execute:
a step of calculating at least one of a traffic volume of people and a traffic volume of vehicles by using a captured image of a road;
a step of estimating a necessity degree that indicates a degree of necessity for executing animal detection processing of detecting an animal by using the captured image, based on the calculated traffic volume;
a step of determining whether to execute the animal detection processing using the captured image, based on the estimated necessity degree; and
a step of, when it is determined that the animal detection processing is to be executed, executing the animal detection processing by using the captured image.

### Supplementary Note 9

An image processing system including:
a traffic volume calculation means for calculating at least one of a traffic volume of people and a traffic volume of vehicles by using a captured image of a road;
a necessity degree estimation means for estimating a necessity degree that indicates a degree of necessity for executing animal detection processing of detecting an animal by using the captured image, based on the calculated traffic volume; and
an execution determination means for determining whether to execute the animal detection processing using the captured image, based on the estimated necessity degree,
wherein, when determining that the animal detection processing is to be executed, the execution determination means causes an apparatus configured to execute the animal detection processing to execute the animal detection processing using the captured image.

### Supplementary Note 10

The image processing system according to supplementary note 9, wherein the necessity degree estimation means specifies a necessity degree associated to the calculated traffic volume of people, based on an appearance possibility of the animal and a degree of influence of the animal on a person that are predetermined in association with the traffic volume of people.

### Supplementary Note 11

The image processing system according to supplementary note 9 or 10, wherein the necessity degree estimation means specifies a necessity degree associated to the calculated traffic volume of vehicles, based on an appearance possibility of the animal and a degree of influence of the animal on a vehicle that are predetermined in association with the traffic volume of vehicles.

### Supplementary Note 12

The image processing system according to any one of supplementary notes 9 to 11, wherein the necessity degree estimation means specifies a necessity degree associated to the calculated traffic volume of people and traffic volume of vehicles, based on an appearance possibility of the animal, a degree of influence of the animal on a person, and a degree of influence of the animal on a vehicle that are predetermined in association with the traffic volume of people and the traffic volume of vehicles.

### Supplementary Note 13

The image processing system according to any one of supplementary notes 10 to 12, wherein the predetermined necessity degree is a necessity degree set according to a type of an animal, an activity range of which includes a location where the image capturing apparatus that generates the captured image is installed.

### Supplementary Note 14

The image processing system according to supplementary note 9, wherein the necessity degree estimation means determines the necessity degree, based on the traffic volume of people or the traffic volume of vehicles and a characteristic of the animal.

### Supplementary Note 15

An image processing method being executed by an image processing apparatus configured to process an image, the method including:
calculating at least one of a traffic volume of people and a traffic volume of vehicles by using a captured image of a road;
estimating a necessity degree that indicates a degree of necessity for executing animal detection processing of detecting an animal by using the captured image, based on the calculated traffic volume;
determining whether to execute the animal detection processing using the captured image, based on the estimated necessity degree; and
when it is determined that the animal detection processing is to be executed, causing an apparatus configured to execute the animal detection processing to execute the animal detection processing using the captured image.

### Supplementary Note 16

A non-transitory storage medium storing an image processing program that causes a computer to execute:
a step of calculating at least one of a traffic volume of people and a traffic volume of vehicles by using a captured image of a road;
a step of estimating a necessity degree that indicates a degree of necessity for executing animal detection processing of detecting an animal by using the captured image, based on the calculated traffic volume;
a step of determining whether to execute the animal detection processing using the captured image, based on the estimated necessity degree; and
a step of, when it is determined that the animal detection processing is to be executed, causing an apparatus configured to execute the animal detection processing to execute the animal detection processing using the captured image.

### REFERENCE SIGNS LIST

1 IMAGE PROCESSING SYSTEM
10 IMAGE PROCESSING APPARATUS
11 PROCESSOR
12 COMMUNICATION INTERFACE
13 STORAGE APPARATUS
100 IMAGE PROCESSING PROGRAM
101 TRAFFIC VOLUME CALCULATION UNIT
102 NECESSITY DEGREE ESTIMATION UNIT
103 EXECUTION DETERMINATION UNIT
104 ANIMAL DETECTION PROCESSING UNIT
20 IMAGE CAPTURING APPARATUS
30 NETWORK
40 IMAGE PROCESSING APPARATUS

What is claimed is:

1. An image processing system comprising:
a memory configured to store instructions; and
a processor configured to execute the instructions to;
calculate at least one of a traffic volume of people and a traffic volume of vehicles by using a captured image of a road;
estimate a necessity degree that indicates a degree of necessity for executing animal detection processing of detecting an animal by using the captured image, based on the calculated traffic volume;
determine whether to execute the animal detection processing using the captured image, based on the estimated necessity degree; and
execute the animal detection processing by using the captured image when it is determined that the animal detection processing is to be executed.

2. The image processing system according to claim 1, wherein the processor is configured to execute the instructions to specify a necessity degree associated to the calculated traffic volume of people, based on an appearance possibility of the animal and a degree of influence of the animal on a person that are predetermined in association with the traffic volume of people.

3. The image processing system according to claim 1, wherein the processor is configured to execute the instructions to specify a necessity degree associated to the calculated traffic volume of vehicles, based on an appearance possibility of the animal and a degree of influence of the animal on a vehicle that are predetermined in association with the traffic volume of vehicles.

4. The image processing system according to claim 1, wherein the processor is configured to execute the instructions to specify a necessity degree associated to the calculated traffic volume of people and traffic volume of vehicles, based on an appearance possibility of the animal, a degree of influence of the animal on a person, and a degree of influence of the animal on a vehicle that are predetermined in association with the traffic volume of people and the traffic volume of vehicles.

5. The image processing system according to claim 2, wherein the predetermined necessity degree is a necessity degree set according to a type of an animal, an activity range of which includes a location where the image capturing apparatus that generates the captured image is installed.

6. The image processing system according to claim 1, wherein the processor is configured to execute the instructions to determine the necessity degree, based on the traffic volume of people or the traffic volume of vehicles and a characteristic of the animal.

7. An image processing method being executed by an image processing apparatus configured to process an image, the method comprising:
calculating at least one of a traffic volume of people and a traffic volume of vehicles by using a captured image of a road;
estimating a necessity degree that indicates a degree of necessity for executing animal detection processing of detecting an animal by using the captured image, based on the calculated traffic volume;
determining whether to execute the animal detection processing using the captured image, based on the estimated necessity degree; and,
when it is determined that the animal detection processing is to be executed, executing the animal detection processing by using the captured image.

8. A non-transitory storage medium storing an image processing program that causes a computer to:
calculate at least one of a traffic volume of people and a traffic volume of vehicles by using a captured image of a road;
estimate a necessity degree that indicates a degree of necessity for executing animal detection processing of detecting an animal by using the captured image, based on the calculated traffic volume;
determine whether to execute the animal detection processing using the captured image, based on the estimated necessity degree; and
execute the animal detection processing by using the captured image when it is determined that the animal detection processing is to be executed.

9-16. (canceled)
